(19) United States
(12) Patent Application Publication
(10) Pub. No.: US 2006/0008099 A1
(43) Pub. Date: Jan. 12, 2006

(54) Acoustic device

(75) Inventors: Henry Azima, Cambridge (GB); Nicholas Patrick Roland Hill, Cambridge (GB); Denis Morecroft, Huntingdon (GB)

Correspondence Address: FOLEY AND LARDNER LLP;SUITE 500, 3000 K STREET NW, WASHINGTON, DC, 20007, US

(73) Assignee: NEW TRANSDUCERS LIMITED

(21) Appl. No.: 10/510,718

(22) PCT Filed: Apr. 10, 2003
(86) PCT No.: PCT/GB03/01538

§ 371 Date: Aug. 11, 2005

(30) Foreign Application Priority Data
Apr. 17, 2002 (GB) 0208760.9
Feb. 7, 2003 (GB) 0302830.5

(51) Int. Cl. H04R 25/00

(52) U.S. Cl. 381/191

(57) ABSTRACT

A bending wave loudspeaker comprising a panel-form radiator and an electromechanical vibration exciter coupled to the radiator, wherein the bending stiffness of the radiator is in the range 0.001 to 1000 Nm, wherein the coupling between the exciter and the radiator is such that a component of the applied energy results in compression waves in the radiator and wherein the radiator has a break in mid-plane symmetry resulting in acoustic radiation. A method of making a bending wave loudspeaker comprising selecting a panel-form radiator and an electromechanical vibration exciter, coupling the exciter to the radiator to have a relationship between the electromechanical impedance of the vibration exciter and the mechanical impedance of the radiator useful to the operating bandwidth of the radiator, arranging the bending stiffness of the radiator to be in the range 0.001 to 1000 Nm, arranging the coupling between the exciter and the radiator to be such that a component of the applied energy results in compression waves in the radiator and providing the radiator with a break in mid-plane symmetry to cause acoustic radiation.

### TECHNICAL FIELD

This invention relates to acoustic devices and more particularly to bending wave acoustic devices, e.g. loudspeakers. Particularly this invention relates to methods and apparatus by which sound energy travelling through a solid body can be converted into out of plane motion that can radiate sound in air. The invention is thus applicable to resonant bending wave panel-form loudspeakers, e.g. of the kind described in WO97/09842.

The invention particularly relates to a method of driving panel-form loudspeakers comprising driving the panel by an exciter along the plane of the panel, that is to say in compression. By the plane of the panel is meant a line running centrally between the large area surfaces of the panel through the section of the panel material, and will be referred to as “compression” drive. If the radiator panel were planar, i.e. flat, the material would move and vibrate but very little sound would be produced because there is very little resulting out-of-plane deflection of the structure. In other words a flat panel can carry mechanical sound energy but it cannot radiate into acoustics efficiently.

### DISCLOSURE OF INVENTION

From one aspect, the invention is a method of making a bending wave loudspeaker comprising selecting a panel-form radiator and an electromechanical vibration exciter, coupling the exciter to the radiator with a desired relationship between the electromechanical impedance of the vibration exciter and the mechanical impedance of the radiator useful to the operating bandwidth of the radiator, arranging the bending stiffness of the radiator to be in the range 0.001 to 1000 Nm, arranging the coupling between the exciter and the radiator to be such that a component of the applied energy results in compression waves in the radiator and providing the radiator with a break in mid-plane symmetry to cause acoustic radiation. Mid-plane symmetry refers to the property of a conventional flat panel that may generally be used as a Distributed Mode Loudspeaker. The mid-plane is an imaginary flat plane parallel to the face of the panel and bisecting the depth of the panel such that the panel is symmetric about this plane. A break in mid-plane symmetry occurs when the properties of the panel are made asymmetric about this mid-plane.

The method may comprise coupling the vibration exciter to an edge of the radiator.

The method may comprise restraining an edge of the radiator opposite to the edge to which the exciter is coupled.

The method may comprise coupling vibration exciters to opposite edges of the radiator.

The method may comprise coupling a plurality of exciters to the radiator.

The method may comprise arranging at least two of the plurality of exciters with their operative axes at an angle.

The method may comprise forming the radiator with a local discontinuity.

The method may comprise locating the local discontinuity near to an edge of the radiator opposite to the edge to which the exciter is coupled.

The method may comprise locating the local discontinuity near to the centre of the radiator.

The method may comprise forming the radiator to be convexly or concavely curved.

The method may comprise forming the curve to be non-uniform.

The method may comprise forming the radiator as a laminate formed from layers of materials having different properties as seen by compression waves, and coupling the exciter to drive the layers.

The method may comprise forming the radiator as a laminate having superposed layers, coupling the exciter to drive one of the layers and restraining the other of the layers at a position remote from the exciter coupling position.

The method may comprise forming the radiator to be of high aspect ratio.

The method may comprise arranging the radiator and the exciter such that the radiator is driven in whole-body motion at low frequencies.

The method may comprise arranging the radiator to resonate at high frequencies.

The method may comprise arranging the radiator to operate as a distributed mode device.

From another aspect, the invention is a bending wave loudspeaker comprising a panel-form radiator and an electromechanical vibration exciter coupled to the radiator, wherein the bending stiffness of the radiator is in the range 0.001 to 1000 Nm, wherein the coupling between the exciter and the radiator is such that a component of the applied energy results in compression waves in the radiator and wherein the radiator has a break in mid-plane symmetry resulting in acoustic radiation.

The bending stiffness of the radiator may be in the range 0.01 to 100 Nm and preferably is in the range 0.01 to 10 Nm.

The vibration exciter may be coupled to an edge of the radiator.

An edge of the radiator opposite to edge to which the exciter is coupled may be restrained.

Vibration exciters may be coupled to opposite edges of the radiator.

A plurality of exciters may be coupled to the radiator. At least two of the exciters may be arranged with their operative axes at an angle.

The radiator may be formed with a local discontinuity. The local discontinuity may be located near to an edge of the radiator opposite to the edge to which the exciter is coupled. The local discontinuity may be located near to the centre of the radiator.

The radiator may be convexly or concavely curved. The curve may be non-uniform.

The radiator may be a laminate of at least two different materials having different properties as seen by compression waves, and the exciter may be coupled to drive the at least two materials.

The radiator may be a laminate comprising at least two layers and the exciter may be coupled to drive one of the layers and another of the layers may be restrained at a position remote from the exciter coupling position.

The radiator may be of high aspect ratio.

The radiator and the exciter may be arranged such that the radiator is driven in whole-body motion at low frequencies.

The radiator and the exciter may be arranged such that the radiator resonates at high frequencies.

The radiator may be arranged to operate as a distributed mode device.

A commonly used method for the excitation of a Distributed Mode Loudspeaker (DML) is by using a moving coil motor. The design of this motor is important to optimize the performance of the DML for bandwidth and sensitivity, but a conflict arises when maximizing both the high and low frequency extension.

At high frequency the theoretical point impedance of a plate is generally real and constant. The moving coil exciter has a mechanical output impedance that at high frequency is dominated by the moving mass of the voice coil assembly plus coupler plus spider suspension arrangement. Consequently for good high frequency performance the voice coil assembly mass is limited according to the following formula:
ωMₘₛ≦8\sqrt{Bμ}

This constraint dictates the design of the motor system, where the moving mass of the voice coil assembly is minimized for best high frequency level.

At low frequency the moving mass of the voice coil assembly is less of a limit. In this region there are generally two concerns. Firstly, the suspension compliance of the device needs to be designed such that the impedance that it represents is small compared to the panel impedance in the frequency band of interest. Secondly, the voice coil assembly needs to be designed for the excursion limit of the device, which is directly related to the power handling and bandwidth of the device. This design limit can be severe as normal program material often has an increasing energy content at low frequencies, increasing the demands for power handling and excursion of the voice coil assembly.

This design is obviously in conflict with the need for a small light voice coil assembly for best high frequency level and large excursion and power handling for best low frequency level. Any design represents a compromise between these two extremes in frequency.

One option to solve this conflict is to maximize the stiffness of the panel used. This has the effect of maximizing the drive point impedance seen by the exciter, allowing the use of heavier voice coils without limiting the high frequency response. The drawback of this method is twofold:
1) Increasing the stiffness of a panel generally increases its mass, which adversely affects the sensitivity of the device. As a result the effect of the increase in stiffness is to extend the bandwidth of the device at the expense of a reduced sensitivity. This may be compensated with a larger magnet applied to the voice coil, however this adds to the cost of the device.
2) For a given size the first bending mode of the device increases with stiffness. As a result the area of the panel would need to be increased for the implementation of a fully modal solution. Alternatively a hybrid solution, whereby the modal response crosses over to a pistonic motion at low frequency is also an option. This brings with it added complication to manage the piston to modal transition.

The present invention provides an increased drive point impedance to an exciter for improved bandwidth both at the high and low frequency ends, while simultaneously reducing the limits on voice coil excursion at the lowest frequencies. Furthermore, the present invention does not require the conventional increased stiffness of panel, allowing low mass panels be used for good sensitivity.

The operation of the device is not limited to frequencies above the first compression resonance of the device, since whole body compression may be used below this frequency. The action of whole body compression, combined with the break in symmetry of the panel, is to present an increased drive point impedance at low frequency, relative to the conventional out of plane arrangement. This method can be used to increase the coupling of energy from the exciter to the panel for relatively low excursions of the voice coil. This compression is released as out of plane movement and is particularly useful in the extension of the response to very low frequencies.

The present invention thus provides a method to improve both the high frequency and low frequency limits of an audio device by relaxing the limits placed on motor design for conventional out of plane excitation.

Many panel shapes can be used with compression drive, e.g. rectangular panels and long narrow strip panels of high aspect ratio. In the present invention, drive energy from the exciter is normally applied to an edge of the panel. At low frequencies the exciter may drive the whole panel but at higher frequencies compression waves form in the material. Compression waves propagate through materials at very high speed compared with bending waves.

For example the velocity of a bending wave in a moderately stiff plastics material may be only 50 m/s at 1 kHz but in the same material the compression wave velocity is 1500 m/s, i.e. 30 times faster. Bending wave velocity depends on both the material stiffness and the frequency so the ratio of wavespeed difference between bending and compression waves is variable and wide but a 10 to 50 times range would be typical.

### BRIEF DESCRIPTION OF DRAWINGS

The invention is diagrammatically illustrated, by way of example, in the accompanying drawings, in which:

FIG. 1a is a front view of a radiator panel and exciter combination;

FIG. 1b is a sectional side view of the combination of FIG. 1a;

FIG. 2 is a sectional side view similar to that of FIG. 1b showing a first method of operation of the loudspeaker of the present invention;

FIG. 3 is a sectional side view similar to that of FIG. 1b showing a second method of operation of the loudspeaker of the present invention;

FIG. 4 is a sectional side view similar to that of FIG. 1b showing a third method of operation of the loudspeaker of the present invention;

FIG. 5 is a sectional side view similar to that of FIG. 1b showing one aspect of a fourth method of operation of the loudspeaker of the present invention;

FIG. 6 is a sectional side view similar to that of FIG. 5 showing another aspect of the fourth method of operation of the loudspeaker of the present invention;

FIG. 7 is a front perspective view of a first embodiment of loudspeaker of the present invention;

FIG. 8a is a front perspective view of a second embodiment of loudspeaker of the present invention;

FIG. 8b is a side view of the loudspeaker of FIG. 8a;

FIG. 8c is a side view, corresponding to that of FIG. 8b, of a modified version of the loudspeaker of FIG. 8a;

FIG. 9 is a front perspective view of a third embodiment of loudspeaker of the present invention.

FIG. 10 is a sectional side view of the speaker of FIG. 9;

FIG. 11 is a graph of out-of-plane velocity of a curved beam-like radiator driven in compression;

FIG. 12 is a graph of a typical acoustic output of a speaker of the kind shown in FIG. 11;

FIGS. 13 to 17 are sectional side views, similar to those of FIGS. 2 to 6 of various different embodiments of speaker according to the present invention;

FIG. 18 is a graph of acoustic output with dual excitation and single end excitation;

FIGS. 19 and 20 are diagrams showing methods of driving a generally rectangular panel;

FIGS. 21 and 22 are diagrams showing methods of driving generally triangular panels;

FIGS. 23a and 23b are respectively a front view and a side view of an ovoid-shaped speaker of the present invention, and

FIGS. 24a and 24b, 25a and 25b and 26a and 26b show respective side and front views of three further embodiments of speaker of the present invention.

### BEST MODES FOR CARRYING OUT THE INVENTION

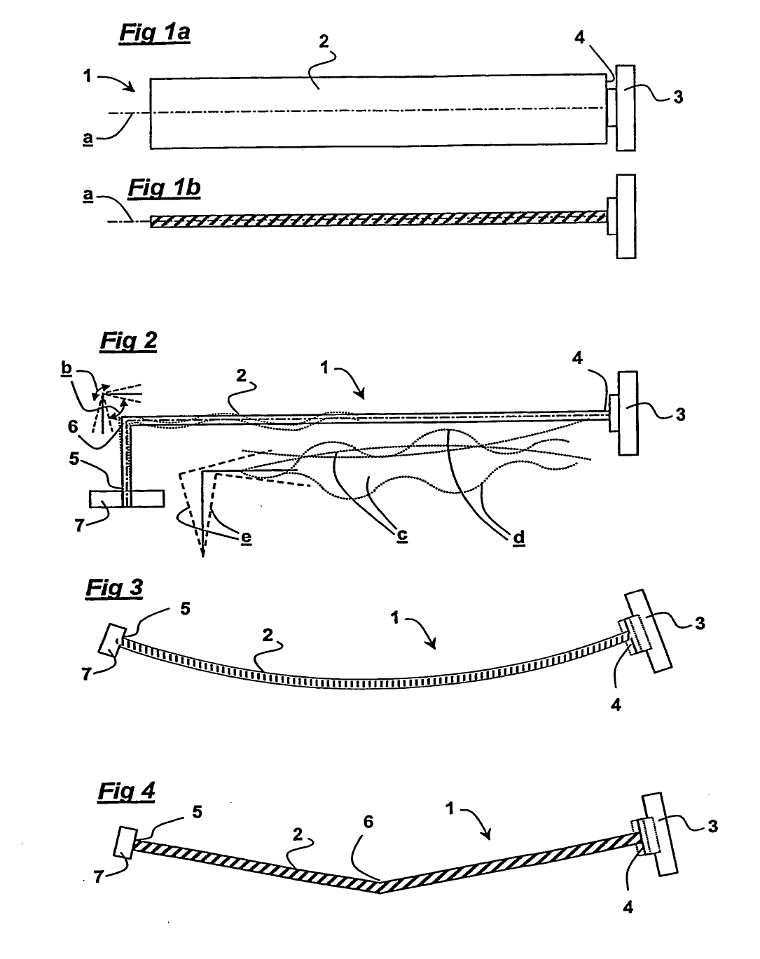

In FIGS. 1a and 1b there is shown a loudspeaker 1 comprising a strip-like panel radiator 2 and a vibration exciter 3 coupled to one end of the radiator. An in-plane line through the radiator 2 is indicated by dotted line a.

A first method according to the present invention of converting in-plane to out-of-plane energy outlined below uses a localised discontinuity in the radiator to convert in-plane movement into out of plane movement, which results in the generation of bending waves. These bending waves then radiate efficiently, in a similar manner to conventional DMLs. In the example shown in FIG. 2 the discontinuity takes the form of a 90-degree bend in the radiator plate.

FIG. 2 shows a loudspeaker 1 having a flat panel radiator 2 and an exciter 3 coupled to drive one end 4 of the radiator. The radiator is bent through an angle or corner 6 at its end 5 opposite to the excitation point 4. In-plane movement from the exciter 3 in the form of compression waves c causes the corner 6 to move in plane as shown by arrows b. This in-plane movement of the corner illustrated by dotted lines e gives rise to a torque about the corner. The torque provides the out of plane stimulus that is responsible for the generation of bending waves illustrated by dotted lines d. It is also clear from this that any discontinuity that gives rise to a torque in response to in plane movement is suitable to convert the in plane energy into acoustically more useful bending waves.

The end of the radiator 5 remote from the exciter 3 is restrained by a mass load or clamp 7.

The local discontinuity or angle method of conversion produces sound in three ways depending on the frequency, as follows:

1) At high frequencies in-plane compression waves cause rotation at the angle and bending waves to form.

2) At middle range frequencies the whole body in-plane movement causes generation of bending waves focussed on the corner position.

3) At low frequencies in-plane whole body movement from the exciter causes out-of-plane whole body flexure of the panel.

It can be seen that using this method the in-plane motion can be converted at a point or a line by discontinuity into out-of-plane motion that can radiate sound over a wide range of frequencies.

If the conversion from in-plane motion to out-of-plane motion is spread out over a distance, instead of acting at a point or a line on the radiator, then the form of the converting device changes to become a curved shape radiator 2 as shown in FIG. 3, which represents a second method according to the invention of converting in-plane to out-of-plane energy.

Therefore an alternative deviation from flatness is a curve which can also convert in-plane motion into out-of-plane motion. To explain how this works it is possible to visualise the curve as many flat sections of panel linked together producing angles spread along the length of the panel. If the number of flat sections is progressively increased (and each one is shortened in length) a smooth curve is ultimately formed. Each individual flat section acts like the angle or corner case described above with reference to FIG. 2. In this way it is possible to see that the curve acts in a similar way to the angle but the conversion from in-plane motion to out-of plane motion is spread evenly over the whole panel length instead of occurring at a point or a line.

There is however an important difference between the angle and the curve methods. At high frequencies, when the in-plane wavelength is less than twice the length of the panel, compression waves form. The out-of-plane component of the compression waves cause the panel to move out-of-plane at the in-plane wavelength. As mentioned earlier compression wavelengths are typically 10 to 50 times longer than bending wavelengths because the compression wavespeed is high. The nature of the acoustic radiation from this extra out-of-plane movement is similar to above fc (coincidence frequency) bending wave radiation, which is efficient but directional and tending to peak in acoustic output off the axis normal to the panel.

The curve method of conversion produces sound in three ways depending on the frequency, as follows:

1) At low frequencies the in-plane whole body movement causes out-of-plane whole body flexure because of the fixture of the panel at the end opposite to the exciter.

2) At middle range frequencies the out-of-plane component of the whole body flexure breaks down into bending waves.

3) At high frequencies in-plane compression waves cause out-of plane motion at the in-plane wavelength and above fc type radiation occurs.

A third method of converting in-plane to out-of-plane energy is shown in FIG. 4 and it is a variation on the first method but with the angle or local discontinuity 6 placed nearer to the centre region of the panel.

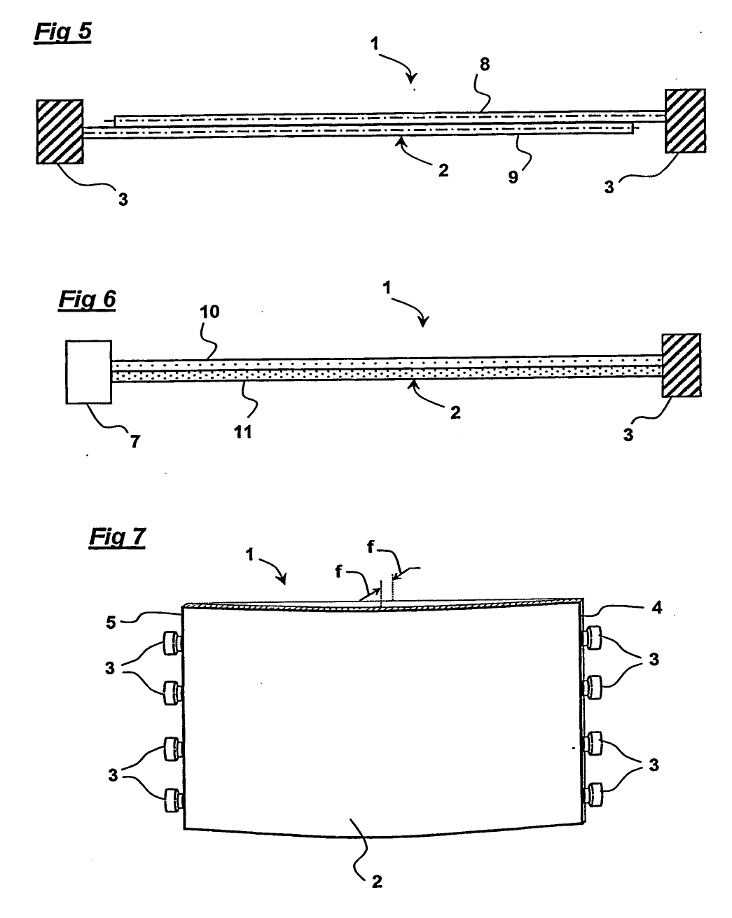

A fourth method of converting in-plane to out-of-plane energy is shown in FIGS. 5 and 6 and uses differential drive of flat laminated panels or flat laminated materials with different stiffness and wave propagation velocity. This method is useful because it enables flat radiators to be employed. It will be appreciated that there is a need to use absolutely flat transparent materials in some view screen applications to control light reflection properties.

In-plane drive of a radiator 2 which is a laminate of two flat materials can produce out-of-plane movement if one layer 8 of the laminate is driven and the other layer 9 is referenced, e.g. to a chassis or mass or is driven in the opposite direction by an exciter 3 as shown in FIG. 5. Each layer 8, 9 of the laminate is driven in opposite directions and the difference in the centre line of each separate layer and the centre line of the laminate produces rotation of the whole laminate and thus acoustic radiation.

FIG. 6 shows how a radiator 2 which is a laminate of two layers 10,11 of materials of different stiffness and wave velocity can be driven in-plane to produce out-of-plane movement. At low frequencies the different stiffness produces out-of-plane whole body flexure and at high frequencies the different compression wave velocity causes rotation and the formation of bending waves.

The differentially driven laminate method of conversion of FIG. 5 produces sound in three ways, as follows:

1) At high frequencies the push-pull action of the in-plane wave causes rotation out-of-plane at the in-plane wavelength

2) At middle range frequencies the differential action below the lowest in-plane resonance releases energy in rotation out-of-plane in the form of bending waves.

3) At low frequencies the differential action of the excitation causes out-of-plane whole body flexure that can radiate sound.

The laminate method of conversion shown in FIG. 6 produces sound from in-plane energy in three ways, as follows:

1) At high frequencies the different rate of propagation of the compression wave in the two bonded plates causes rotation which results in out-of-plane movement at in-plane wavelengths.

2) At middle range frequencies the different propagation velocities below the lowest in-plane resonance releases energy out-of-plane in the form of bending waves.

3) At low frequencies the different in-plane stiffness of the two plates causes out-of-plane whole body flexure that can radiate sound.

FIG. 7 is of a first embodiment of loudspeaker 1 of the present invention comprising a rectangular panel radiator 2 convexly curved across its width and with a row of four exciters 3 coupled to the opposite ends 4,5 of the radiator. The panel material consists of a transparent monolithic material for operation as a flat panel loudspeaker to be placed in front of a display screen to produce a combined speaker and display.

The panel loudspeaker is intended to operate as a modal compression wave device at high frequencies and as a modal bending wave device at middle range audio frequencies. The in-plane method of excitation can also be designed to cause the panel to operate as a flexible whole body radiator at low frequencies. The three types of operation, compression, bending and whole body flexure combine to enable a loudspeaker of the present embodiment to cover a wide part of the whole audio frequency spectrum. In particular this embodiment gives a wider useful frequency range than a purely bending wave radiator.

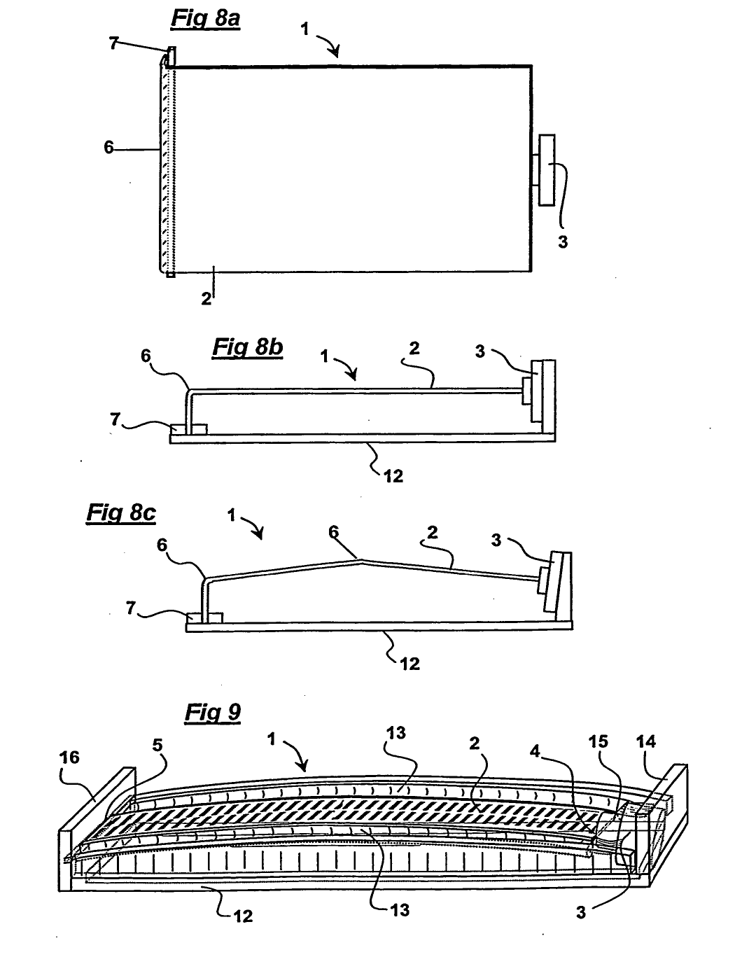

In a second embodiment of loudspeaker 1 shown in FIGS. 8a and 8b a panel/speaker viewing screen can be flat which is a requirement for controlling optical reflection characteristics in some applications. When the panel radiator is driven in-plane by an exciter 3 the energy is converted into bending by the angled edge or corner 6 on the opposite side of the radiator. As the radiator moves in-plane the angle 6, which is mass loaded or simply supported against a chassis 12, rotates and imparts the energy back into the radiator as bending waves.

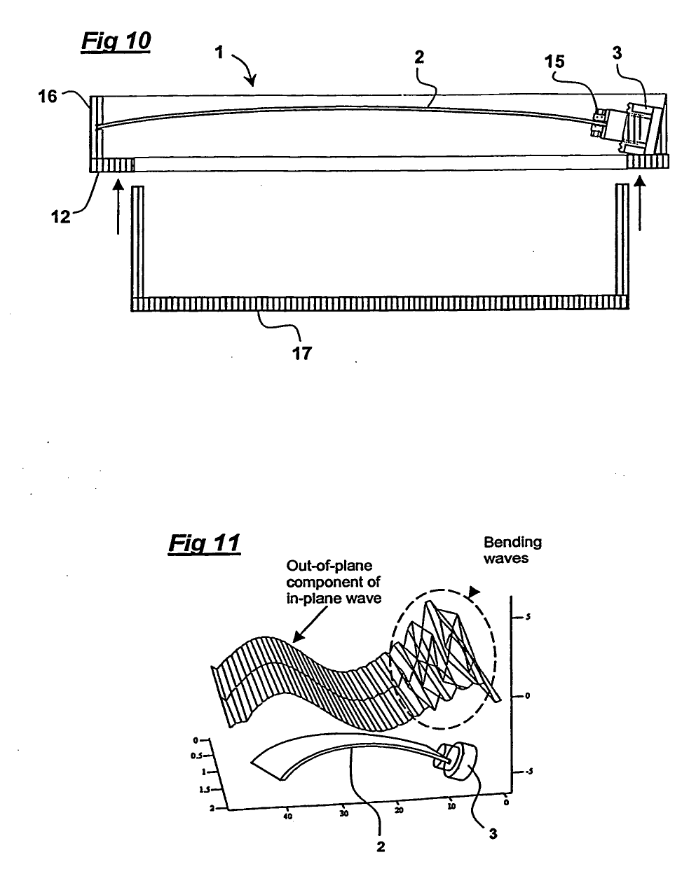

In a variation of the second embodiment shown in FIG. 8c two flat sections of panel 2 are joined by an open angle or by a short curve 6. The method may not be suitable for a view screen application because the angle 6 is in the central region of the panel where it would interfere with the transparency. The method lends itself to high aspect ratio designs in which the angle defines the exciter magnification in the same manner as the curve height in the embodiment of FIGS. 9 and 10 below.

FIGS. 9 and 10 illustrate a practical embodiment of a high aspect ratio panel speaker 1. Such loudspeaker devices may be extremely advantageous in applications that have restricted space requirements. Examples include stereo side speakers in a television or. monitor application.

The embodiment shown in FIGS. 9 and 10 consists of a convexly curved panel radiator 2 with dimensions 400 mm×50 mm×5 mm thick with a curve height of 40 mm. The panel radiator 2 is mounted in a frame or chassis 12 with a flexible suspension 13 along the length of each side allowing unrestricted movement of the radiator while preventing the free flow of air between the front and back of the panel. A pre-shaped suspension is designed to allow up/down and lengthwise movement between the panel and the chassis and it is fixed between the chassis 12 and the panel 2 all along the length of the curve. An air seal is also fitted around the vibration transducer 3. The suspension 13 is not required to hold the panel in position so it can be a simple design made from suitably flexible lightweight flat material. The suspension can be fitted to the panel by means of an adhesive and to the chassis with clamping plates.

One end 14 of the chassis supports an electrodynamic moving coil transducer 3 precisely aligned to apply force to the panel 2 in its plane. The transducer is fixed to the end edge 4 of the panel by means of a clamp 15 and the opposite end 5 of the panel is held stationary by fixing it firmly to the opposite end 16 of the chassis 12. At very low frequencies the combination of in-plane excitation and the curved shape of the panel produces out-of-plane whole body flexure that radiates sound. The curve height is chosen to magnify the exciter movement and this significantly increases the mechanical load impedance on the transducer allowing high drive force to be applied even at the lowest audio frequencies.

The whole body flexure is the lowest mode of the panel and depending on the air loading at the rear of the panel frequencies as low as 40 Hz can be produced. As the frequency rises bending modes are excited that radiate sound. As the frequency increases further above the frequency of the lowest compression mode the curved shape of the panel causes the in-plane resonances to exhibit an out-of-plane component. This out of plane component gives rise to efficient radiation of sound similar to above fc bending wave radiation.

FIG. 10 shows a sectional view of the high aspect ratio panel of FIG. 9. As shown in FIG. 10, the chassis 12 may optionally comprise a so-called infinite baffle enclosure to contain rear radiation from the radiator 2.

The advantages of compression drive include the following:

1. There is no transducer aperture effect at high frequencies.

2. The mechanical drive impedance presented to the transducer can be designed and made high enough at all frequencies so that the moving mass of the transducer is less critical.

3. Compressed edge drive can produce the same output level as out-of-plane central drive giving a major advantage in situations where excitation must be made from the edge.

Concerning power transfer from the exciter to the panel, in many applications excitation in-plane improves the suitability of the load impedance for drive by a conventional moving coil exciter. At low frequencies, when driving lightweight panel materials that require large exciter excursion with out-of-plane excitation, the in-plane exciter loading remains high down to the lowest frequencies because a curved panel acts as a lever magnifying the exciter movement. At high frequencies the longer in-plane wavelength maintains a high load on the exciter so that the voice coil mass is less important and at very high frequencies compression waves extend the bandwidth beyond the audio range. In some applications excitation with small movement high force piezo exciters is also feasible with in-plane drive.

The parameters of the exciter used in the first embodiment of FIG. 7 are shown below.

Zhejiang Tianle 25

| | |
|---|---|
| Coil former diameter = | 25 mm |
| Number of coil layers = | 2 |
| Mms = | 0.683 gm (Moving mass of the voice |
| | coil assembly) |
| Rms = | 0.103 Ns/m (Mechanical resistance |
| | of suspension) |
| Bl = | 3.564 Tm (Motor conversion factor) |
| Re = | 9.62 ohm (DC resistance of voice |
| | coil) |
| Le = | 1.4 uH (Inductance factor of voice |
| | coil at 1 kHz) |
| Cms = | 0.196e−3 m/N (Compliance of |
| | suspension) |

The panel material used in the high aspect ratio embodiment along with its technical parameters is given below

Material Rotrex Lite 51LS (Trade Name) 5 mm thick core of polymethacrylimide thermoplastic foam with a glass veil/thermoplastic skin. Panel size 400 mm×50 mm.

| | | | |
|---|---|---|---|
| Mass Area Density | M | 0.447 | Kg/m2 |
| Bending rigidity | D1 | 4.011 | Nm |
| Bending rigidity | D2 | 5.244 | Nm |
| Thickness | T | 5 | mm |

An explanation of the relationship between curve height and in-plane to out-of-plane conversion will now be given. A lower curve height has a larger curve radius and when driven in-plane this gives greater magnification of the exciter movement and a more extended low frequency response but with lower sensitivity.

A compression driven curved panel therefore acts as a lever with some unusual properties. At low frequencies the centre moves out-of-plane as the exciter pushes along the plane of the panel. More curvature equates to a smaller radius which results in less exciter movement magnification but more out-of-plane component from the in-plane energy.

FIG. 11 shows a laser measurement of the out-of-plane velocity of a curved beam being driven in-plane. The long wavelength formed at the left end of the trace is the start of the impulse that has already moved along the length of the beam. It is the out-of-plane component of the compression wave revealing the in-plane wavelength for this material. Behind it at the right end of the beam a burst of bending waves has formed which will spread more slowly along the beam. The in-plane and bending wave amplitudes are similar and the combination of both wave types produce modes and sound output from the curved panel.

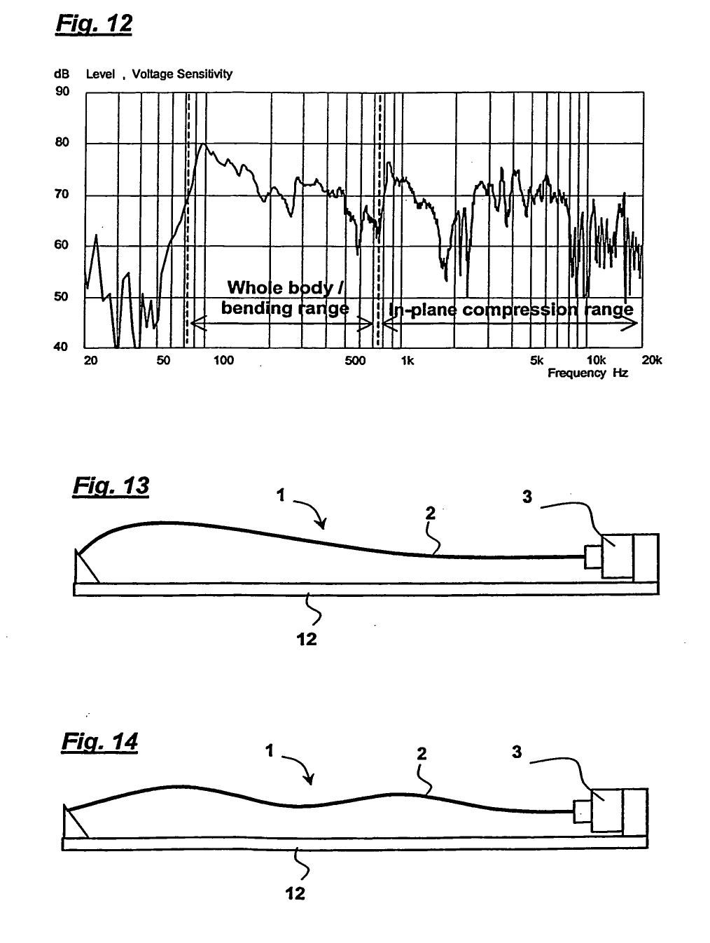

An example of a typical acoustic measurement is shown in FIG. 12. The on-axis output is shown with 1 volt input from a 40 mm high curve 390 mm×50 mm mounted in a wall baffle.

The speaker of the present invention can be modified in many ways to vary the radiating area, to adapt the panel to the exciter, to control both types of modal distribution, to change the air loading which affects the bandwidth and to change the high frequency dispersion. As shown in FIG. 10, an enclosure may be used to prevent front-to-back cancellation and in this case the loading conditions are subject to the same restrictions that apply to conventional enclosed loudspeakers. Some examples of possible modifications are shown in FIGS. 13 to 17.

In FIG. 13, there is shown a loudspeaker 1 of the same general kind as in FIGS. 9 and 10, and where the radiator 2 has a variable curve along its length.

Referring to FIG. 14, there is shown a speaker 1 of the same kind as in FIG. 13, but where the radiator 2 is formed with multiple curves along its length.

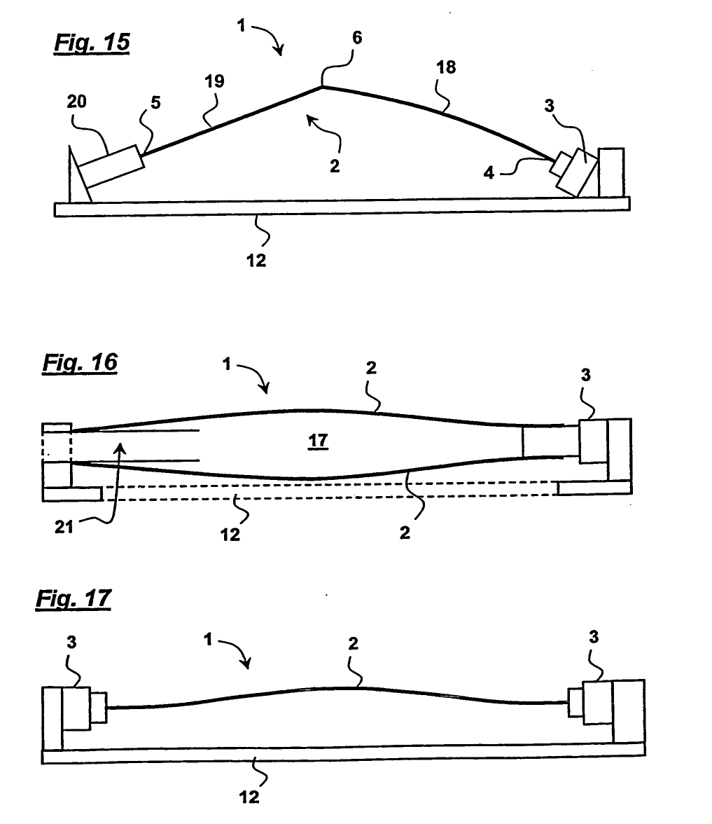

In FIG. 15, there is shown a speaker 1 of the general kind of FIG. 13, and where the radiator is formed with a local discontinuity or corner 6 near to its middle and where one half 18 of the radiator 2 is curved and the other half 19 is plane. The end 4 of the radiator 2 is driven by a moving coil exciter 3, while the end 5 of the radiator is driven by a piezoelectric exciter 20.

In FIG. 16 a speaker 1 comprises a pair of curved radiator beam acting together but also acting as an enclosure 17. Special measures would be needed to control the internal pressure of the enclosed volume such as the enclosure port 21 as shown. Excitation can be applied at both ends of the panel as shown in FIG. 17.

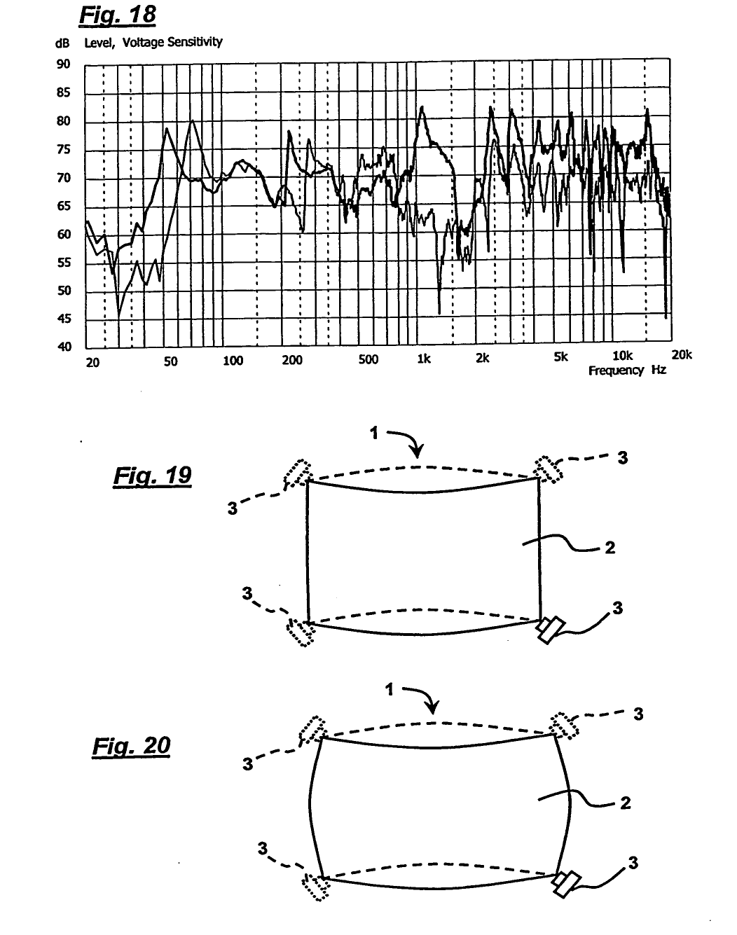

The graph in FIG. 18 shows the acoustic difference dual excitation makes. The acoustic output is similar in the low frequency range up to 1 kHz except that the ultimate low frequency extension and power handling is greater with dual exciters. Above 1 kHz the output is higher.

Two dimensional panels driven in-plane will now be discussed. The illustration in FIG. 10 is a one-dimensional section view for clarity. Panels other than the high aspect ratio shapes in the embodiment of FIGS. 9 and 10 can also be driven in compression and there are several ways of converting the in-plane energy into out-of-plane motion.

FIG. 19 shows a rectangular panel radiator 2 with a curved surface in one plane that can be driven at one or more places e.g. in the corners to convert in-plane motion into sound radiation. The listener could be on either side of the panel facing a convex or concave surface. Dotted lines show that the panel 2 may be convexly or concavely curved. The exciters 3 are arranged in the direction of the curve and it can be applied at a side or corner position with advantages arising from the ability to drive at the edge boundaries without loss of output compared with central out-of-plane drive.

FIG. 20 shows a rectangular panel radiator 2 with a curved surface in two planes that can also be driven at one or more places e.g. in the corners to convert in-plane motion into sound radiation. Dotted lines show that the panel 2 may be convexly or concavely curved. In this case some extra stiffness is available from the shaping and the stiffness and mass of the panel material may be reduced with benefits in sensitivity.

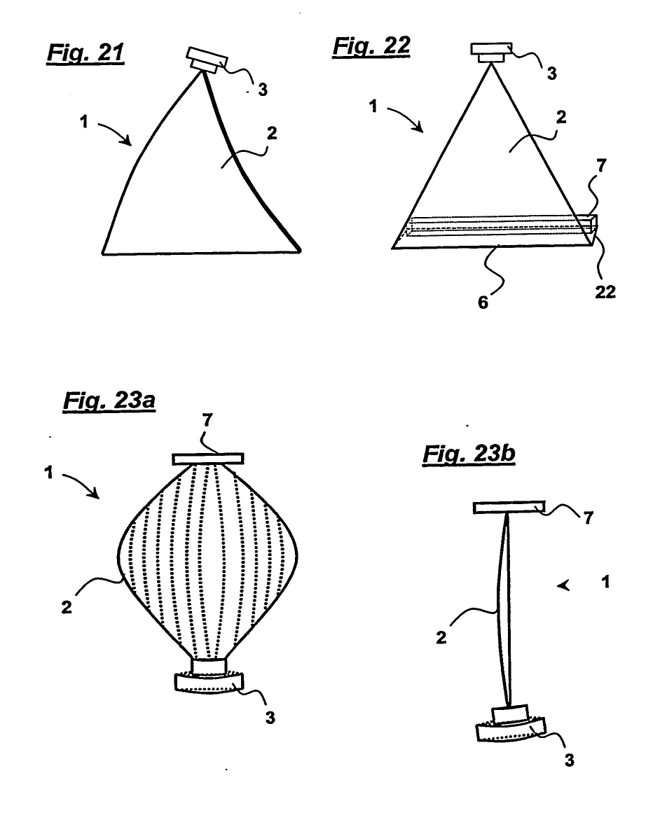

Shapes other than rectangular, e.g. triangular can be operated with in-plane drive. The curved triangular panel radiator 2 shown in FIG. 21 can be driven from any of its corners and FIG. 22 shows a flat triangular panel radiator 2 with an angled base 22 acting as a wave converter

FIGS. 23a and 23b show in front and side views an example of speaker with an ovoid shaped radiator 2 that is sized to fit an exciter 3 at the drive point but which increases in area towards the centre. The panel is curved in the vertical direction to generate out-of-plane movement from the in-plane energy of the exciter.

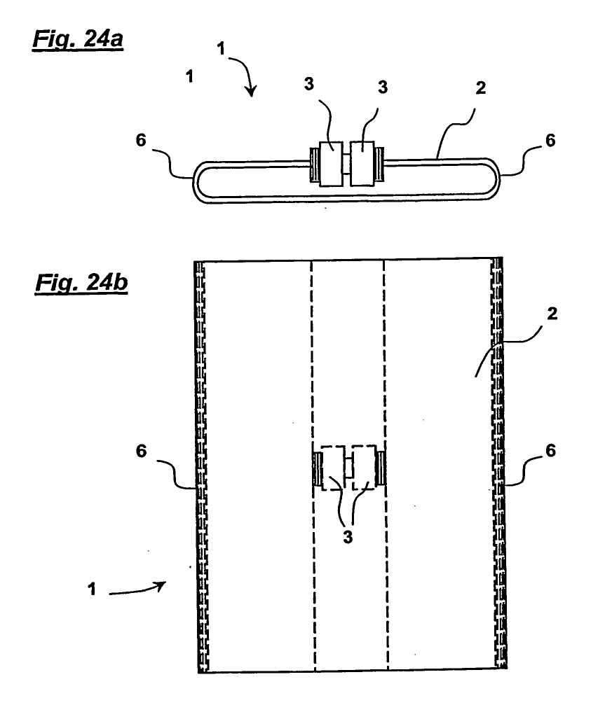

FIGS. 24a and 24b show in plan and rear view embodiment of speaker 1 using compression drive of a radiator 2 used as a transparent display panel. Two exciters 3 are linked back to back driving outwards into the plane of the panel 2 where it folds back at corners 6 to form an almost closed loop. This method has the advantage that all the exciter force is expended into the plane of the panel at all frequencies i.e. the exciters are self referencing. Conversion into bending and whole body flexure occurs at the two corners giving low frequency extension and the impression of central excitation at higher frequencies.

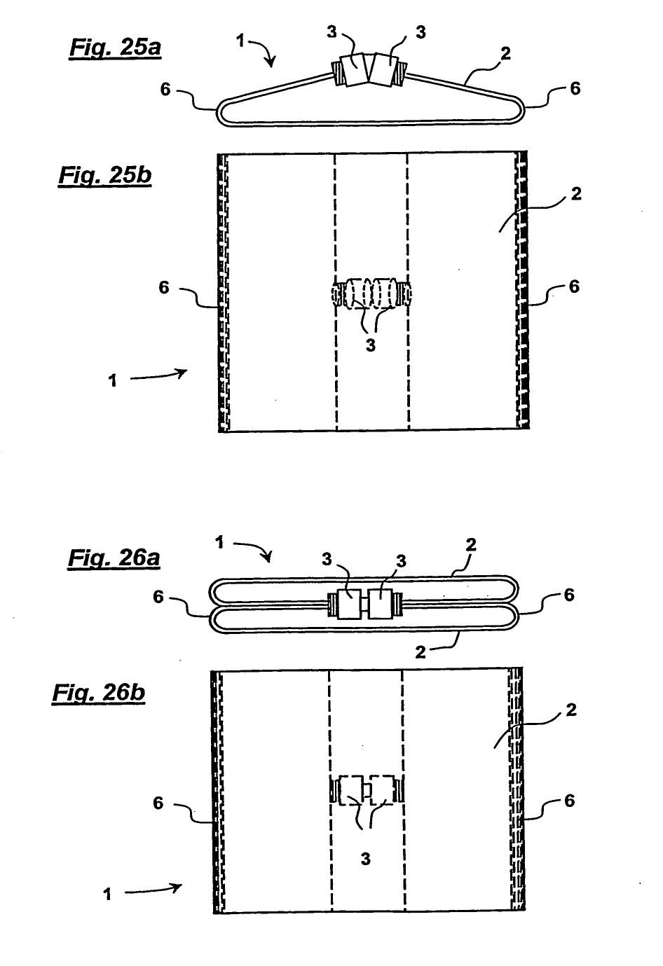

FIGS. 25a and 25b show in plan and front view another version of speaker 1 of the same general kind as in FIGS. 24a and 24b and designed to enhance the sound output of the system. The angle of the folds in the radiator at 6 allows some control of the mechanical impedance of the panel as seen by the exciters.

FIGS. 26a and 26b show in plan and front view how a speaker of the general kind of FIG. 24 but comprising two surface sound panel radiators 2 can be laminated together and driven in-plane. The low frequency performance is enhanced because the laminated section ensures that the moments generated at the two corners 6 cancel so all the energy goes into bending the front and back panel radiators in flexure.

1. A bending wave loudspeaker comprising a panel-form radiator and an electromechanical vibration exciter coupled to the radiator, wherein the bending stiffness of the radiator is in the range 0.001 to 1000 Nm, wherein the coupling between the exciter and the radiator is substantially in the plane of the radiator such that a component of the applied energy results in compression waves in the radiator and wherein the radiator has a break in mid-plane symmetry resulting in acoustic radiation.

2. A loudspeaker according to claim 1, wherein the vibration exciter is coupled to an edge of the radiator.

3. A loudspeaker according to claim 2, wherein an edge of the radiator opposite to the edge to which the exciter is coupled is restrained.

4. A loudspeaker according to claim 2, wherein vibration exciters are coupled to opposite edges of the radiator.

5. A loudspeaker according to any one of claims 1 to 4, wherein a plurality of exciters are coupled to the radiator and at least two of the exciters are arranged with their operative axes at an angle.

6. A loudspeaker according to claim 1, wherein the radiator is formed with a local discontinuity.

7. A loudspeaker according to claim 6, wherein the local discontinuity is located near to an edge of the radiator opposite to the edge to which the exciter is coupled.

8. A loudspeaker according to claim 6, wherein the local discontinuity is located near to the centre of the radiator.

9. A loudspeaker according to claim 1, wherein the radiator is convexly or concavely curved.

10. A loudspeaker according to claim 9, wherein the curve is non-uniform.

11. A loudspeaker according to claim 1, wherein the radiator is a laminate comprising layers of at least two materials having different properties as seen by compression waves and wherein the exciter is coupled to drive the at least two layers.

12. A loudspeaker according to claim 1, wherein the radiator is a laminate comprising at least two layers, wherein the exciter is coupled to drive one of the layers and wherein another of the layers is restrained at a position remote from the exciter coupling position.

13. A loudspeaker according to claim 1, wherein the radiator is of high aspect ratio.

14. A loudspeaker according to claim 1, wherein the radiator and the exciter are arranged such that the radiator is driven in whole-body motion at low frequencies.

15. A loudspeaker according to claim 1, wherein the radiator and the exciter are arranged such that the radiator resonates at high frequencies.

16. A loudspeaker according to claim 15, wherein the radiator is arranged to operate as a distributed mode device.

17. A method of making a bending wave loudspeaker comprising selecting a panel-form radiator and an electromechanical vibration exciter, coupling the exciter to the radiator to have a relationship between the electromechanical impedance of the vibration exciter and the mechanical impedance of the radiator useful to the operating bandwidth of the radiator, arranging the bending stiffness of the radiator to be in the range 0.001 to 1000 Nm, arranging the coupling between the exciter and the radiator to be substantially in the plane of the radiator such that a component of the applied energy results in compression waves in the radiator and providing the radiator with a break in mid-plane symmetry to cause acoustic radiation.

18. A method according to claim 17, comprising coupling the vibration exciter to an edge of the radiator.

19. A method according to claim 18, comprising restraining an edge of the radiator opposite to edge to which the exciter is coupled.

20. A method according to claim 18, comprising coupling vibration exciters to opposite edges of the radiator.

21. A method according to any one of claims 17 to 20, comprising coupling a plurality of exciters to the radiator and arranging at least two of the exciters with their operative axes at an angle.

22. A method according to claim 17, comprising forming the radiator with a local discontinuity.

23. A method according to claim 22, comprising locating the local discontinuity near to an edge of the radiator opposite to the edge to which the exciter is coupled.

24. A method according to claim 22, comprising locating the local discontinuity near to the centre of the radiator.

25. A method according to claim 17, comprising forming the radiator to be convexly or concavely curved.

26. A method according to claim 25, comprising forming the curve to be non-uniform.

27. A method according to claim 17, comprising forming the radiator as a laminate comprising layers of materials having different properties as seen by compression waves, and coupling the exciter to drive the layers.

28. A method according to claim 17, comprising forming the radiator as a laminate having superposed layers, coupling the exciter to drive one of the layers and restraining the other of the layers at a position remote from the exciter coupling position.

29. A method according to claim 17, comprising forming the radiator to be of high aspect ratio.

30. A method according to claim 17, comprising arranging the radiator and the exciter such that the radiator is driven in whole-body motion at low frequencies.

31. A method according to claim 17, comprising arranging the radiator to resonate at high frequencies.

32. A method according to claim 31, comprising arranging the radiator to operate as a distributed mode device.

33. A loudspeaker according to claim 9, wherein the radiator is a laminate comprising layers of at least two materials having different properties as seen by compression waves and wherein the exciter is coupled to drive the at least two layers.

34. A loudspeaker according to claim 9, wherein the radiator is a laminate comprising at least two layers, wherein the exciter is coupled to drive one of the layers and wherein another of the layers is restrained at a position remote from the exciter coupling position.

35. A method according to claim 25, comprising forming the radiator as a laminate comprising layers of materials having different properties as seen by compression waves, and coupling the exciter to drive the layers.

36. A method according to claim 25, comprising forming the radiator as a laminate having superposed layers, coupling the exciter to drive one of the layers and restraining the other of the layers at a position remote from the exciter coupling position.
